(19) United States
(12) Patent Application Publication
(10) Pub. No.: US 2010/0045914 A1
(43) Pub. Date: Feb. 25, 2010

(54) LIQUID CRYSTAL DISPLAY DEVICE

(75) Inventors: Toshiyuki MIMA, Chiba (JP); Yasumitsu Fujita, Chiba (JP); Kazunori Zenba, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/546,800

(22) Filed: Aug. 25, 2009

(30) Foreign Application Priority Data
Aug. 25, 2008 (JP) 2008-215463

(51) Int. Cl. G02F 1/1337; G02F 1/13

(52) U.S. Cl. 349/126; 349/187

(57) ABSTRACT

An IPS-type liquid crystal display device which can prevent the occurrence of meshes flaw irregularities at the time of forming a sealing material for adhering a TFT substrate and a counter substrate by screen printing is provided. Rubbing which determines the initial alignment direction of liquid crystal molecules and a pretilt angle is applied to the TFT substrate and the counter substrate. In the IPS-type liquid crystal display device, it is necessary to set a pretilt angle to 2.5 degrees or less. The sealing material for adhering the TFT substrate and the counter substrate is formed on the counter substrate by screen printing. By setting an angle made by the squeezing direction in screen printing and the rubbing direction to a value which falls within a range from 165 degrees to 195 degrees, it is possible to prevent the occurrence of meshes flaw irregularities.

### CLAIM OF PRIORITY

The present application claims priority from Japanese application serial No. 2008-215463, filed on Aug. 28, 2008, the content of which is hereby incorporated by reference into this application.

### BACKGROUND OF THE INVENTION

1. Field of the Invention

The present invention relates to a display device, and more particularly to a liquid crystal display device which suppresses the generation of irregularities in a display region when a sealing material is formed by printing.

2. Description of Related Art

In a liquid crystal display device, a TFT substrate which mounts pixel electrodes, thin film transistors (TFT) and the like thereon in a matrix array and a counter substrate which mounts color filters and the like at positions thereof corresponding to the pixel electrodes on the TFT substrate are arranged to face each other, and liquid crystal is sandwiched between the TFT substrate and the counter substrate. An image is formed by controlling optical transmissivity of liquid crystal molecules for every pixel.

The TFT substrate and the counter substrate are adhered to each other by way of a sealing material which is formed on a periphery of the counter substrate. As a method for forming the sealing material on the counter substrate, there has been known a method which uses a dispenser. If the sealing material can be formed by screen printing in place of the dispenser, the productivity of the liquid crystal display device can be enhanced.

However, in forming the sealing material by screen printing, it is necessary to bring a printing mask into contact with the counter substrate. Then, a paste which constitutes the sealing material is applied to the counter substrate from above the printing mask using a squeeze. The printing mask is formed of meshes, and the meshes have the uneven surface. On the other hand, color filters and the like are formed on the counter substrate, an alignment film for aligning liquid crystal is formed on the color filters and the like, and the alignment of liquid crystal is determined by rubbing the alignment film in the particular direction.

In JP-A-5-100233 (patent document 1), there is the description that in forming a sealing material by printing, the degree of occurrence of contrast irregularities differs depending on the operational direction of a squeeze and the direction of rubbing.

### SUMMARY OF THE INVENTION

In forming the sealing material by screen printing, to reduce the influence of meshes of the printing mask, there has been proposed a means which increases the number of meshes and decreases a diameter of each line. However, such a means cannot sufficiently reduce the influence of meshes of the printing mask. Further, there has been also proposed a means which applies a so-called calendar treatment for leveling a surface of meshes by applying pressure to the surface of the meshes. However, this means also cannot sufficiently reduce the influence of meshes of the printing mask. When a suspended metal is used for forming a printing mask in place of printing meshes, surface irregularities are eliminated from the printing mask and hence, the generation of mesh irregularities is also eliminated. However, the application of the suspend metal to a large-sized substrate is difficult.

With respect to the technique described in patent document 1, there is the description that contrast irregularities can be eliminated by setting the alignment direction of the counter substrate and the operational direction of a squeeze in screen printing within a particular range. Patent document 1 describes that contrast irregularities can be eliminated by setting an angle made by the rubbing direction and the operational direction of the squeeze (the direction of squeezing) to 60 degrees or more.

However, the technique described in patent document 1 cannot acquire a sufficient mesh influence reducing effect particularly when the liquid crystal display device is an IPS (In Plane Switching) type liquid crystal display device. In the IPS-type liquid crystal display device, a pretilt angle of liquid crystal is set to 2.5 degrees or less. In this manner, the IPS-type liquid crystal display device has the different constitution compared to a conventional TN (Twisted Nematic) type liquid crystal display device or the like and hence, it is considered that a phenomenon which differs from a phenomenon which occurs when a printing step is applied to the conventional liquid crystal display device arises.

It is an object of the present invention to eliminate mesh irregularities when a sealing material is formed by screen printing which uses a printing mask formed of meshes in case of the IPS-type liquid crystal display device.

To overcome the above-mentioned drawbacks, the present invention adopts the following specific means.

(1) According to one aspect of the present invention, there is provided a liquid crystal display device which includes: a TFT substrate on which pixels each of which includes a pixel electrode and a TFT are formed in a matrix array, the pixels being covered with a TFT-substrate-side alignment film; a counter substrate on which the color filters are formed, the color filters being covered with a counter-substrate-side alignment film; liquid crystal which is sandwiched between the TFT-substrate-side substrate alignment film and the counter-substrate-side alignment film; and a sealing material which is formed on a periphery of the counter substrate for adhering the TFT substrate and the counter substrate to each other, wherein rubbing treatment having the rubbing direction is applied to the counter-substrate-side alignment film formed on the counter substrate, and a pretilt angle imparted to liquid crystal molecules by the rubbing treatment is set to 2.5 degrees or less, and

the sealing material is formed by screen printing, and an angle made by the squeezing direction in the screen printing and the rubbing direction falls within a range from 165 degrees to 195 degrees.

(2) In the liquid crystal display device having the constitution (1), an angle made by the rubbing direction and the squeezing direction is set to a value which falls within a range from 170 degrees to 190 degrees.

(3) In the liquid crystal display device having the constitution (1), the pretilt angle imparted to the liquid crystal molecules by rubbing is 2.0 degrees or less.

(4) According to another aspect of the present invention, there is provided a method of manufacturing a liquid crystal display device which includes: a TFT substrate on which pixels each of which includes a pixel electrode and a TFT are formed in a matrix array, the pixels being covered with a TFT-substrate-side alignment film; a counter substrate on which the color filters are formed, the color filters being covered with a counter-substrate-side alignment film; liquid crystal which is sandwiched between the TFT-substrate-side substrate alignment film and the counter-substrate-side alignment film; and a sealing material which is formed on a periphery of the counter substrate for adhering the TFT substrate and the counter substrate to each other, the method including the steps of: applying rubbing treatment to the counter-substrate-side alignment film formed on the counter substrate such that a pretilt angle imparted to liquid crystal molecules becomes 2.5 degrees or less; and forming the sealing material on the counter substrate by screen printing such that an angle made by the rubbing direction in the rubbing treatment and the squeezing direction in the screen printing falls within a range from 165 degrees to 195 degrees.

(5) In the method of manufacturing a liquid crystal display device having the above-mentioned constitution (4), the sealing material is formed on the counter substrate by screen printing such that an angle made by the rubbing direction and the squeezing direction falls within a range from 170 degrees to 190 degrees.

(6) In the method of manufacturing a liquid crystal display device having the above-mentioned constitution (4), the rubbing treatment is applied such that the pretilt angle becomes 2.0 degrees or less.

According to the present invention, in the IPS-type liquid crystal display device, it is possible to form the sealing material which adheres the TFT substrate and the counter substrate to each other by screen printing and hence, a time for performing a step for forming the sealing material can be largely shortened. Further, according to the present invention, by determining the rubbing direction with respect to the alignment film formed on the counter substrate and the squeezing direction in screen printing for forming the sealing material, it is possible to prevent mesh mark irregularities attributed to printing meshes used in screen printing.

### BRIEF DESCRIPTION OF THE DRAWINGS

FIG. 1 is a plan view of a liquid crystal display device to which the present invention is applied;

FIG. 2 is a plan view of a mother substrate;

FIG. 3 is a cross-sectional view of an IPS-type liquid crystal display device;

FIG. 4 is a plan view showing the rubbing direction and the printing direction;

FIG. 5 is a graph showing the relationship between the difference between the rubbing direction and the printing direction and a yield rate of products;

FIG. 6 is a schematic plan view of a printing machine;

FIG. 7 is a schematic view showing screen printing; and

FIG. 8 is a plan view of meshes.

### DESCRIPTION OF THE PREFERRED EMBODIMENTS

The present invention is explained in detail in conjunction with embodiments hereinafter.

### Embodiment 1

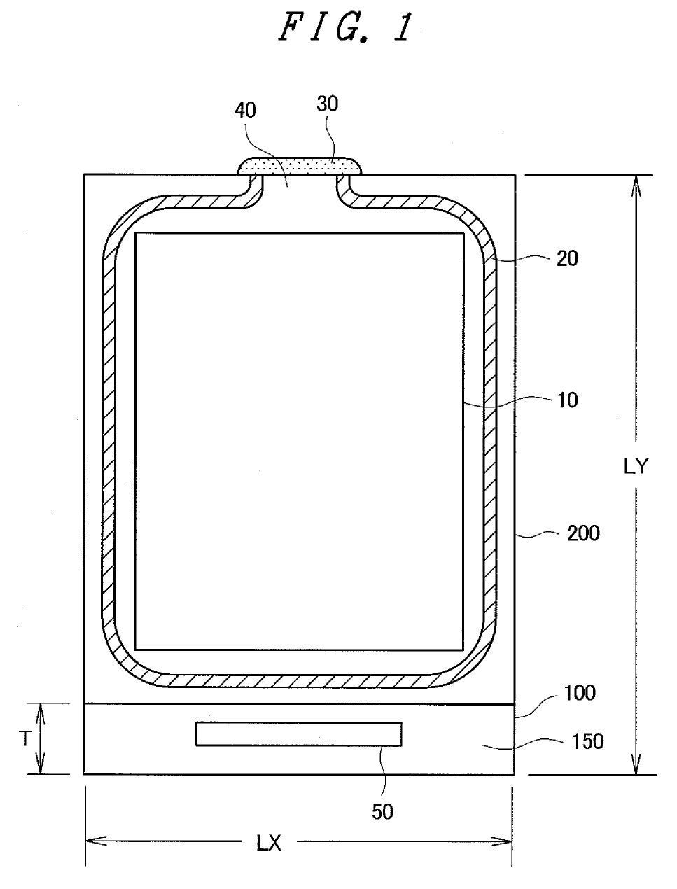

FIG. 1 is a plan view of a liquid crystal display device according to the present invention which is used for a mobile phone or the like. In FIG. 1, a counter substrate 200 is mounted on a TFT substrate 100. A liquid crystal layer 300 is sandwiched between the TFT substrate 100 and the counter substrate 200. The TFT substrate 100 and the counter substrate 200 are adhered to each other by a sealing material 20 which is formed between picture frame portions of these substrates. The TFT substrate 100 is formed larger than the counter substrate 200 in size, and a terminal portion 150 for supplying electricity, video signals, scanning signals and the like to a liquid crystal cell 1 is formed on a portion of the TFT substrate 100 which projects outwardly from the counter substrate 200. Further, an IC driver 50 for driving scanning lines, video signal lines and the like is formed on the terminal portion 150.

In FIG. 1, the liquid crystal cell 1 has a longitudinal length LY of 81 mm and a lateral length LX of 54 mm. Further, the terminal portion 150 on which the IC driver 50 and the like are mounted has a width T of 2.7 mm. A portion ranging from a display-region 10 to an edge portion of the TFT substrate 100 or the counter substrate 200 constitutes a picture frame portion. On the picture frame portion, in addition to the sealing material 20, lead lines led from the scanning lines and the like not shown in the drawing are arranged.

In FIG. 1, the sealing material is made of a thermosetting epoxy resin. The sealing material is firstly applied to the counter substrate by screen printing, and the counter substrate is overlapped to the TFT substrate. Then, the sealing material is cured by baking and, thereafter, liquid crystal is injected into a gap defined between the substrates. Finally, an injection hole is sealed by a sealing member.

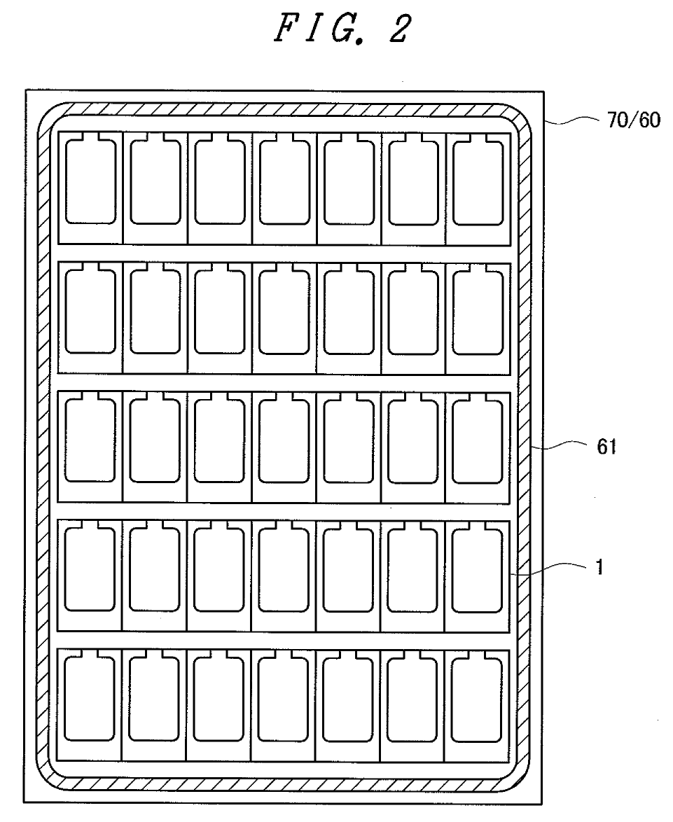

The liquid crystal display device shown in FIG. 1 is a small-sized display device and hence, the manufacture of the liquid crystal display devices on a one-by-one basis is inefficient. To overcome this drawback, as shown in FIG. 2, a plurality of liquid crystal cells is formed on a large-sized mother substrate and, thereafter, the mother substrate is separated into a plurality of liquid crystal cells. In this specification, a display device which is completed by mounting the IC driver and the like thereon is referred to as the liquid crystal display device, and the structure obtained by merely overlapping the TFT substrate and the counter substrate is referred to as the liquid crystal cell.

In FIG. 2, a mother TFT substrate 60 and a mother counter substrate 70 are overlapped to each other by way of the sealing materials 20 provided corresponding to the respective liquid crystal cells 1 and a mother substrate sealing material 61. The mother substrate sealing material 61 is formed so as to prevent the intrusion of a polishing liquid into the inside of the mother substrate which may occur when the mother TFT substrate 60 and the mother counter substrate 70 are made thin due to polishing of both substrates after the mother substrate is completed. Accordingly, when it is unnecessary to polish the mother TFT substrate 60 or the mother counter substrate 70, the mother substrate sealing material 61 becomes unnecessary.

In FIG. 2, the sealing material 20 of each liquid crystal cell 1 and the mother substrate sealing material 61 are formed on the mother counter substrate 70 by screen printing. The sealing materials can be formed more efficiently by screen printing than a conventional method which uses a dispenser for forming the sealing materials. However, as explained later, in forming the sealing material by screen printing, it is necessary to take a countermeasure to overcome mesh flaw irregularities attributed to contacting of meshes with an alignment film.

In the liquid crystal display device, to impart initial alignment to liquid crystal, an alignment film is formed on the TFT substrate 100 and the counter substrate 200 and, then, the alignment film is rubbed in the particular direction so as to decide the direction of the initial alignment. Although an angle of liquid crystal molecules on the alignment film, that is, a so-called pretilt angle of the liquid crystal molecules is set at the time of performing a rubbing treatment, when the liquid crystal display device is an IPS-type liquid crystal display device, it is necessary to set the pretilt angle small compared to an ordinary liquid crystal display device. That is, it is necessary to set the pretilt angle to 2.5 degrees or less, for example. When the pretilt angle is small in this manner, the influence attributed to the contacting of a printing mask in screen printing is increased.

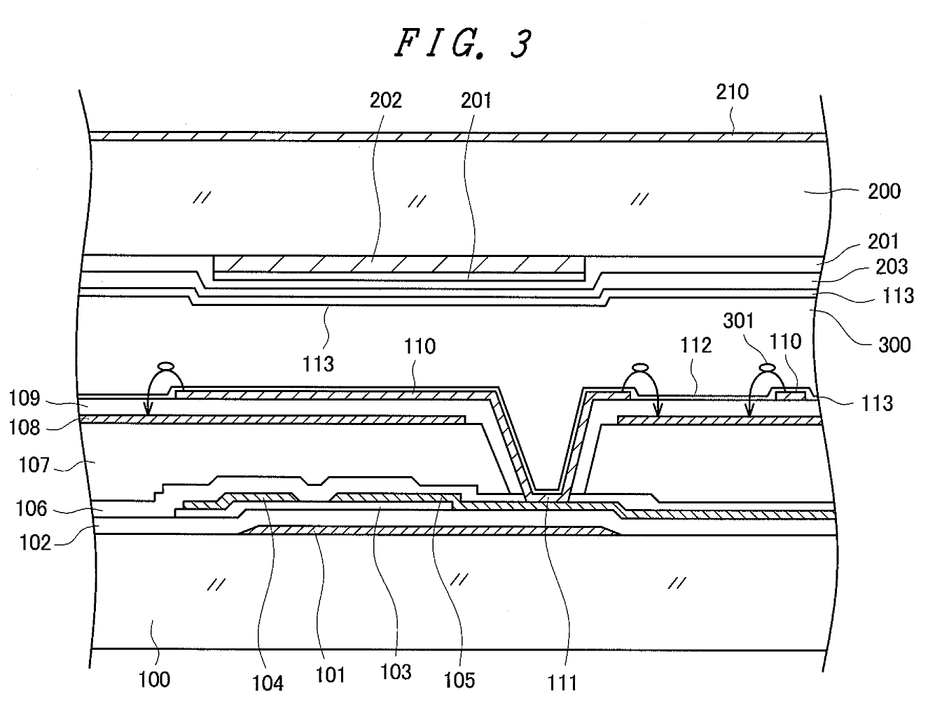

FIG. 3 is a cross-sectional view of the IPS-type liquid crystal display device (referred to as an IPS hereinafter). Here, although there are various kinds of IPSs, FIG. 3 shows one example of the IPS. FIG. 3 is a cross-sectional view showing a portion around a TFT of the IPS. In FIG. 3, gate electrodes 101 are formed on the TFT substrate 100 which is formed of a glass substrate. The gate electrodes 101 are formed on the same layer as the scanning lines. The gate electrode 101 is formed by stacking a MoCr alloy layer on an AlNd alloy layer.

A gate insulation film 102 made of SiN is formed on the TFT substrate 100 in a state that the gate insulation film 102 covers the gate electrodes 101. A semiconductor layer 103 made of a-Si is formed on the gate insulation film 102 at a position where the semiconductor layer 103 faces the gate electrode 101 in an opposed manner. The a-Si films are formed by plasma CVD. The a-Si film constitutes a channel portion of the TFT, and a source electrode 104 and a drain electrode 105 are formed on the a-Si film with the channel portion sandwiched therebetween. Here, an n+Si layer not shown in the drawing is formed between the a-Si film and the source electrode 104 or between the a-Si film and the drain electrode 105 for establishing an ohmic contact between the semiconductor layer and the source electrode 104 or the drain electrode 105.

The video signal line also functions as the source electrode 104, and the drain electrode 105 is connected to a pixel electrode 110. Both the source electrodes 104 and the drain electrodes 105 are simultaneously formed on the same layer. In this embodiment, the source electrodes 104 or the drain electrodes 105 are made of a MoCr alloy. When it is necessary to decrease electric resistance of the source electrode 104 or the drain electrode 105, for example, the electrode structure where an AlNd alloy layer is sandwiched between MoCr alloy layers is used.

An inorganic passivation film 106 made of SiN is formed on the TFT substrate 100 in a state that the inorganic passivation film 106 covers the TFTs. The inorganic passivation film 106 is provided for protecting the TFTs, particularly, the channel portions of the TFTs from impurities. An organic passivation film 107 is formed on the inorganic passivation film 106. The organic passivation film 107 plays a role of leveling a surface of the TFT as well as a role of protecting the TFT and hence, the organic passivation film 107 has a large thickness. That is, the thickness of the organic passivation film 107 is set to 1 μm to 4 μm.

The organic passivation film 107 is formed using a photosensitive acrylic resin, a silicon resin, a polyimide resin or the like. It is necessary to form through holes in the organic passivation film 107 at positions where the pixel electrodes 110 and the drain electrodes 105 are connected with each other. Since the organic passivation film 107 is a photosensitive film, the through holes can be formed by exposing and developing the organic passivation film 107 per se without using a photoresist.

The counter electrode 108 is formed on the organic passivation film 107. The counter electrode 108 is formed by sputtering ITO (Indium Tin Oxide) for forming a transparent conductive film on the whole display region. That is, the counter electrode 108 is formed into a planar shape. After forming the counter electrode 108 on the whole surface of the display region by sputtering, only through hole portions by which the pixel electrodes 110 and the drain electrodes 105 are made conductive with each other are formed by removing by etching the counter electrode 108.

An upper insulation film 109 made of SiN is formed on the TFT substrate 100 in a state that the upper insulation film covers the counter electrode 108. After the upper insulation film 109 is formed, through holes are formed in the upper insulation film 109 by etching. Through holes 111 are formed by etching the inorganic passivation film 106 using the upper insulation film 109 as a resist. Thereafter, an ITO film which is provided for forming the pixel electrodes 110 is formed on the TFT substrate 100 by sputtering in a state that the ITO film covers the upper insulation film 109 and the through holes 111. The pixel electrodes 110 are formed by patterning the ITO film formed by sputtering. The ITO film which is provided for forming the pixel electrodes 110 is also coated on the through holes 111. The drain electrode 105 which extends from the TFT and the pixel electrode 110 become conductive with each other via the through hole 111 so that a video signal is supplied to the pixel electrode 110.

The pixel electrode 110 is formed of comb-teeth-shaped electrodes with both ends thereof closed. A slit 112 is formed between the comb-teeth-shaped electrode and the comb-teeth-shaped electrode. A fixed voltage is applied to the counter electrode 108, and a voltage corresponding to the video signal is applied to the pixel electrode 110. When a voltage is applied to the pixel electrode 110, as shown in FIG. 3, lines of electric force are generated so that liquid crystal molecules 301 are rotated in the direction of the lines of electric force thus allowing a light from a backlight to pass through the pixel. The transmission of light from the backlight is controlled for every pixel leading to the formation of an image. Here, an alignment film 113 for aligning the liquid crystal molecules 301 is formed on the pixel electrodes 110.

In an example shown in FIG. 3, the counter electrodes each having a planar shape are formed on the organic passivation film 107, and the comb-teeth electrodes 110 are arranged on the upper insulation film 109. However, opposite to the above, the pixel electrodes 110 each having a planar shape may be arranged on the organic passivation film 107, and the comb-teeth-shaped counter electrode 108 may be arranged on the upper insulation film 109.

In FIG. 3, the counter substrate 200 is provided in a state that the liquid crystal layer 300 is sandwiched between the TFT substrate 100 and the counter substrate 200. Color filters 201 are formed on an inner side of the counter substrate 200. The color filter 201 of red, green or blue is formed for every pixel thus forming a color image. A light blocking film 202 is formed between the color filters 201 thus enhancing a contrast of the image. Here, the light blocking film 202 also functions as a light blocking film for the TFT thus preventing an optical current from flowing into the TFT.

An overcoat film 203 is formed in a state that the overcoat film 203 covers the color filters 201 and the light blocking films 202. The overcoat film 203 has two functions, that is, a function of preventing color filter materials from contaminating the liquid crystal layer and a function of alleviating excessive surface irregularities of the color filter surfaces. An alignment film 113 which determines the initial alignment of liquid crystal is formed on the overcoat film 203. There may a case that the overcoat film 203 is not used. FIG. 3 shows the IPS and hence, the counter electrode is formed on the TFT substrate and hence, the counter electrode is not formed on the counter substrate.

As shown in FIG. 3, in the IPS, a conductive film is not formed on an inner side of the counter substrate 200. Accordingly, a potential of the counter substrate 200 becomes unstable. Further, electromagnetic noises intrude into the liquid crystal layer 300 from the outside, and the image quality is influenced by the electromagnetic noises. To eliminate such a problem, a surface conductive film 210 is formed on an outer side of the counter substrate 200. The surface conductive film 210 which is formed of a transparent film is formed by sputtering ITO.

The sealing material 20 which adheres the counter substrate 200 and the TFT substrate 100 to each other is generally formed on the counter substrate 200. Further, at a point of time that the sealing material 20 is formed, as shown in FIG. 2, the sealing material 20 is applied to the mother counter substrate 70 on which the plurality of counter substrates 200 is formed. In the present invention, the sealing material 20 is applied to the counter substrate 200 by screen printing. Hereinafter, “the rubbing direction of the alignment film 113” or “the squeezing direction in the screen printing” is a phrase which is used with respect to the constitution of the counter substrate 200.

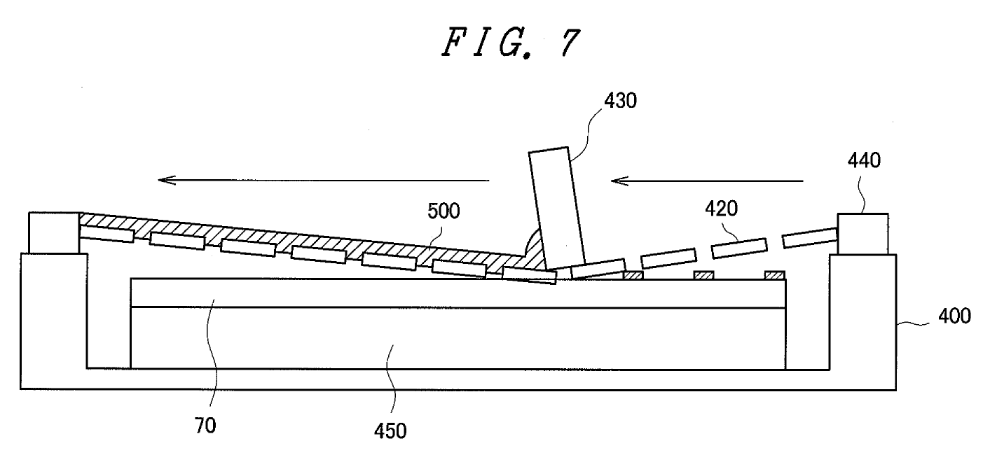

FIG. 7 is a schematic view of the screen printing. In FIG. 7, the mother counter substrate 70 is arranged on a mounting base 450 of the screen printing machine 400. As described later, the mounting base 450 is rotatable. In the screen printing machine 400, a printing mask 410 is mounted using mask clamps 440. The printing mask 410 is usually arranged above the mother counter substrate 70 with a slight gap therebetween.

A printing paste 500 which becomes the sealing material 20 is placed on the printing mask 410. The printing paste 500 which becomes the sealing material 20 is made of a thermosetting epoxy resin. When a squeezee 430 is moved in a state where pressure is applied to the printing mask 410 by the squeezee from above, the printing paste 500 is extruded. Due to the extrusion of the printing paste 500, the sealing material 20 is printed on the mother substrate in accordance with a pattern of the printing mask 410. Hereinafter, this operation is referred to as squeezing. Further, the moving direction of the squeezee 430 is referred to as the squeezing direction or the printing direction.

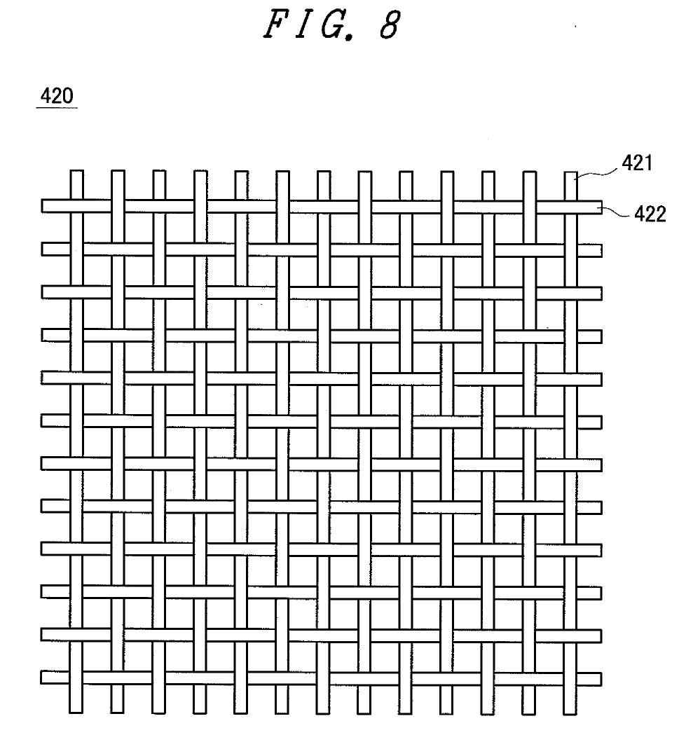

The printing mask 410 is formed of meshes 420 shown in FIG. 8, and the meshes 420 are generally formed using stainless-steel wires (threads). The stainless-steel screen meshes 420 are usually woven by a method which is usually referred to as “plain weaving” so that the meshes 420 are formed in a state where the stainless-steel threads are curved from each other.

As shown in FIG. 8, surface unevenness is formed on a surface of the meshes 420 by weft threads 422 and warp threads 421. As shown in FIG. 7, in the screen printing, the surface unevenness of the meshes 420 is brought into contact with a surface of the alignment film 113 to which the rubbing treatment is already applied, and this contact influences the state of the alignment film 113. To be more specific, mesh mark irregularities occur in such a manner that meshes 420 are transferred.

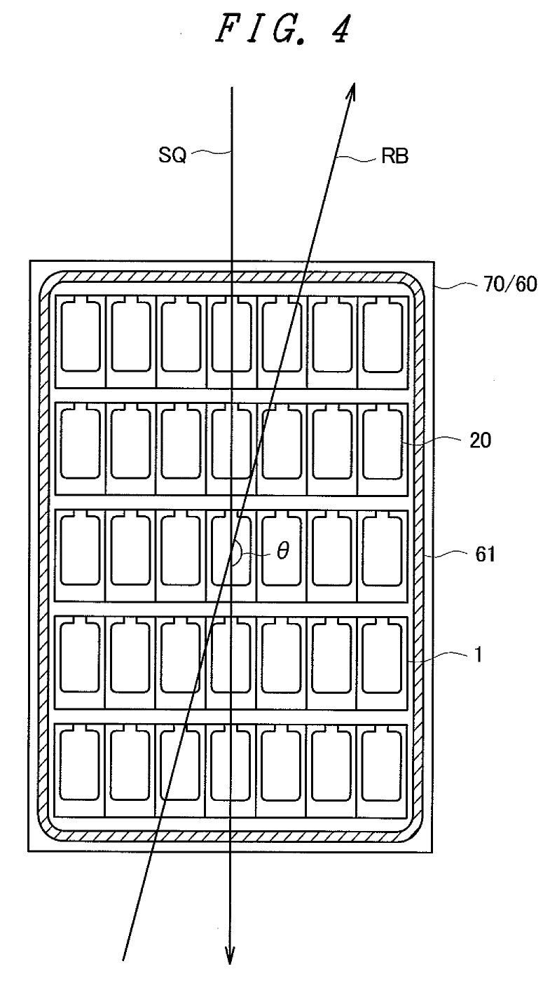

The mesh mark irregularities do not always occur in the same manner, and are largely influenced by the relationship between the rubbing direction of the alignment film 113 and the printing direction. FIG. 4 shows the relationship between the rubbing direction RB of the alignment film 113 on the mother counter substrate 70 and the printing direction (squeezing direction) SQ by the squeeze 430. In FIG. 4, an angle made by the rubbing direction RB and the printing direction SQ is set as θ. Even when the screen printing is performed in the same manner, a magnitude of the occurrence of the mesh mark irregularities largely differs depending on the angle θ.

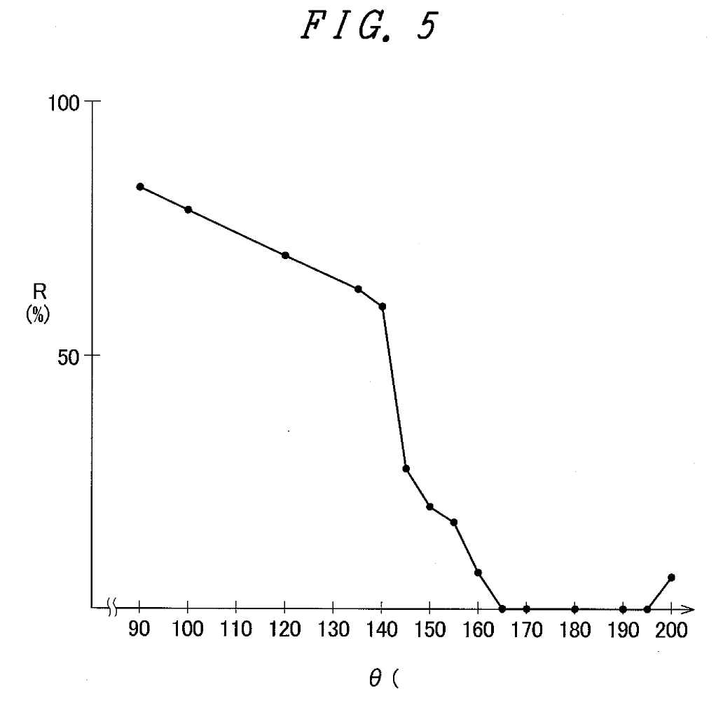

FIG. 5 shows the relationship between an angle θ made by the rubbing direction RB and the squeezing direction SQ and an occurrence frequency R of the mesh mark irregularities. In FIG. 5, the angle θ made by the rubbing direction RB and the squeezing direction SQ is taken on an axis of abscissas, and the occurrence frequency R of mesh mark irregularities is taken on an axis of ordinates. FIG. 5 is data on an IPS-type liquid crystal display device.

As shown in FIG. 5, the occurrence rate of meshes flaw irregularities largely differs depending on the angle made by the rubbing direction and the squeezing direction. In the IPS-method, a range where the meshes flaw irregularities can be prevented is limited to an extremely narrow range. This content largely differs from a content disclosed in patent document 1.

That is, patent document 1 suggests that when the angle made by the rubbing direction and the squeezing direction is within 60 degrees or more, such an angle is within an allowable range with respect to the occurrence rate of meshes flaw irregularities. However, in the IPS method, this range is not allowable at all. This is because that, in the IPS, it is necessary to set a pretilt angle of the alignment film 113 to 2.5 degrees or less, and more preferably to 2.0 degrees or less and hence, an action of the printing meshes 420 exerted on the alignment film 113 may also differ compared to a usual liquid crystal display device.

As can be understood from FIG. 5, with respect to the angle made by the rubbing direction and the squeezing direction, an extremely narrow range from 165 degrees to 195 degrees becomes an allowable range. In other words, it is necessary to set the rubbing direction and the squeezing direction within ±15 degrees taken from the opposite directions.

On the other hand, to take the setting accuracy of the squeezing direction and the setting accuracy of the rubbing direction into consideration, by setting the rubbing direction and the squeezing direction within a range of ±10 degrees taken from the opposite directions, in other words, by setting the angle made by the rubbing direction and the squeezing direction within 170 degrees to 190 degrees, it is possible to surely prevent the meshes flaw irregularities while ensuring tolerance in a printing step also with respect to the IPS method.

In this manner, by accurately managing the angle θ made by the rubbing direction RB and the printing direction SQ, it is possible to suppress the occurrence of meshes flaw irregularities. It is possible to suppress the rubbing direction RB within a range of 0.2 degrees or less. According to the present invention, the screen printing is performed by setting the angle θ made by the rubbing direction RB and the squeezing direction SQ within a range of ±15 degrees, and more preferably, within a range of ±10 degrees taken from the opposite directions in addition to the above-mentioned conditions.

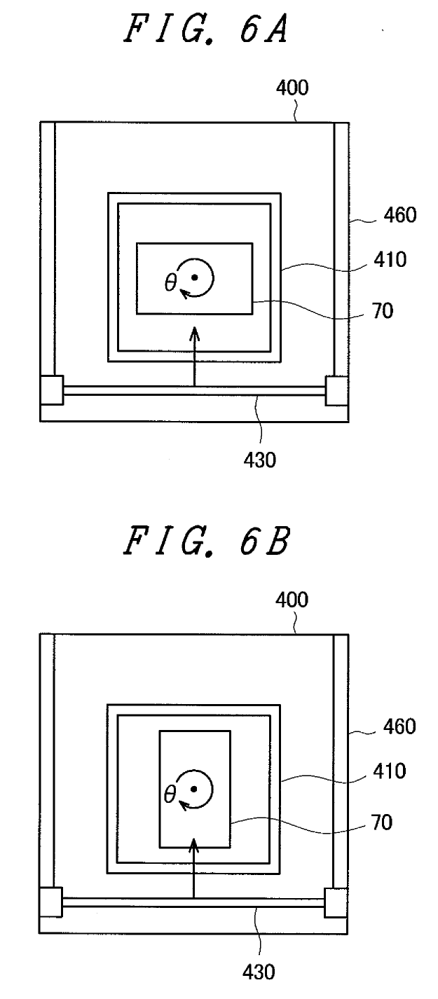

FIG. 6A and FIG. 6B are schematic plan views of screen printing for controlling the printing direction SQ. FIG. 6A shows a case where the printing direction is set in the short-axis direction with respect to the mother substrate. In FIG. 6A, the printing mask 410 is arranged above the mother counter substrate 70. The printing mask 410 has an area larger than an area of the mother counter substrate 70.

In FIG. 6A, the squeezee 430 is mounted on the screen printing machine, the squeezee 430 is moved while being guided by rails 460, and the sealing material 20 is printed on the mother counter substrate 70. The mother counter substrate 70 is mounted on the mounting base 450 of the printing machine not shown in the drawing. The mounting base 450 is rotatable and hence, the mother counter substrate 70 is also rotated simultaneously with the rotation of the mounting base 450. Since the printing mask 410 is formed larger than the mother counter substrate 70, it is possible to set the angle θ made by the rubbing direction RB and the printing direction SQ shown in FIG. 6A to an arbitrary value.

FIG. 6B shows a case where the mounting base 450 is rotated so as to perform the printing from the long axis direction of the mother counter substrate 70. Other constitutions of the printing machine are substantially equal to the corresponding constitutions explained in conjunction with FIG. 6A. By rotating the mother counter substrate 70 without changing a state of the printing machine, it is possible to set the angle θ made by the rubbing direction RB and the printing direction SQ to an arbitrary value.

As has been explained heretofore, according to the present invention, it is possible to form the sealing material 20 by screen printing while suppressing the occurrence of meshes flaw irregularities. Accordingly, a turnaround time for forming the sealing material 20 can be largely shortened.

What is claimed is:

1. A liquid crystal display device comprising:
a TFT substrate on which pixels each of which includes a pixel electrode and a TFT are formed in a matrix array, the pixels being covered with a TFT-substrate-side alignment film;
a counter substrate on which the color filters are formed, the color filters being covered with a counter-substrate-side alignment film;
liquid crystal which is sandwiched between the TFT-substrate-side alignment film and the counter-substrate-side alignment film; and
a sealing material which is formed on a periphery of the counter substrate for adhering the TFT substrate and the counter substrate to each other, wherein
rubbing treatment having the rubbing direction is applied to the counter-substrate-side alignment film formed on the counter substrate, and a pretilt angle imparted to liquid crystal molecules by the rubbing treatment is set to 2.5 degrees or less, and
the sealing material is formed by screen printing, and an angle made by the squeezing direction in the screen printing and the rubbing direction falls within a range from 165 degrees to 195 degrees.

2. A liquid crystal display device according to claim 1, wherein an angle made by the rubbing direction and the squeezing direction is set to a value which falls within a range from 170 degrees to 190 degrees.

3. A liquid crystal display device according to claim 1, wherein the pretilt angle imparted to the liquid crystal molecules by rubbing is set to 2.0 degrees or less.

4. A method of manufacturing a liquid crystal display device which includes: a TFT substrate on which pixels each of which includes a pixel electrode and a TFT are formed in a matrix array, the pixels being covered with a TFT-substrate-side alignment film; a counter substrate on which the color filters are formed, the color filters being covered with a counter-substrate-side alignment film; liquid crystal which is sandwiched between the TFT-substrate-side substrate alignment film and the counter-substrate-side alignment film; and a sealing material which is formed on a periphery of the counter substrate for adhering the TFT substrate and the counter substrate to each other, the method comprising the steps of:
applying rubbing treatment to the counter-substrate-side alignment film formed on the counter substrate such that a pretilt angle imparted to liquid crystal molecules becomes 2.5 degrees or less; and
forming the sealing material on the counter substrate by screen printing such that an angle made by the rubbing direction in the rubbing treatment and the squeezing direction in the screen printing falls within a range from 165 degrees to 195 degrees.

5. A method of manufacturing a liquid crystal display device according to claim 4, wherein the sealing material is formed on the counter substrate by screen printing such that an angle made by the rubbing direction and the squeezing direction falls within a range from 170 degrees to 190 degrees.

6. A method of manufacturing a liquid crystal display device according to claim 4, wherein the rubbing treatment is applied such that the pretilt angle becomes 2.0 degrees or less.
